(19) United States
(12) Patent Application Publication
(10) Pub. No.: US 2020/0158215 A1
(43) Pub. Date: May 21, 2020

(54) SWITCH DEVICE, ACTUATOR, CLUTCH DEVICE AND LAUNDRY MACHINE

(71) Applicant: NIDEC SANKYO CORPORATION, Nagano (JP)

(72) Inventor: Yuta OSHIMA, Nagano (JP)

(21) Appl. No.: 16/679,597

(22) Filed: Nov. 11, 2019

(30) Foreign Application Priority Data
Nov. 20, 2018 (JP) 2018-216932

(51) Int. Cl. F16H 25/16; D06F 37/40; F16D 11/08; F16H 59/68

(52) U.S. Cl. CPC F16H 25/16; D06F 37/40; F16D 2121/18; F16H 59/68; F16D 11/08

(57) ABSTRACT

To provide a switch device in which a switch lever and an energizing member can efficiently be incorporated, an actuator, a clutch device and a laundry machine.

### CROSS-REFERENCE TO RELATED APPLICATIONS

The present application claims priority under 35 USC 119 to Japanese Patent Application No. 2018-216932 filed on Nov. 20, 2018 the entire contents of which are incorporated herein by reference.

### FIELD OF TECHNOLOGY

At least an embodiment of the present invention relates to a switch device equipped with an energizing member to energize a switch lever, an actuator, a clutch device and a laundry machine.

### BACKGROUND

A cam gear may be provided to a transmission mechanism which transmits the rotation force of a motor to an output member and the angle position of the cam gear may be detected by a switch device to monitor the position of the output member. A configuration of a switch device has been proposed in which a switch lever, an energizing member, and a push-type switch are provided; in this switch device, the energizing member energizes the switch lever in one direction around the axis to make the switch lever abut on the cam surface of the cam gear. The energizing member is a torsion coil spring, for example, arranged around a center axis of rotation of the switch lever; one end portion of the switch lever is supported by the switch lever and the other end portion is supported by a support member (Patent Reference 1)

### PRIOR ART REFERENCE

### Patent Reference

[Patent Reference 1] Unexamined Japanese Patent Application 2011-214667 Publication

### SUMMARY

With a configuration of the switch device disclosed in Patent Reference 1 in which a switch device is energized by an energizing member, the energizing member and the switch lever need to be incorporated together having the energizing member deformed, which requires more time and effort. Especially, when the energizing member is a torsion coil spring, a body part of the switch lever needs to be put through inside a wound part of the coil spring, and while being relaxed, the torsion coil spring needs to be incorporated together with the switch lever, requiring more time and effort.

Considering the above problem, an objective of at least an embodiment of the present invention is to provide a switch device in which a switch lever and an energizing member can efficiently be incorporated, an actuator, a clutch device and a laundry machine.

To solve the above problem, the switch device of at least an embodiment of the present invention comprises a support member having a lever support part and a spring receiving part, a switch lever having a body part which is supported by the lever support part to be rotatable around an axis and a first lever which extends from the body part in a direction crossing the axis, an energizing member having a first arm part supported by the first lever part and a second arm part supported by the spring receiving part to energize the switch lever in one direction around the axis, and a switch which switches the state thereof according to the position of the switch lever; wherein the switch lever is provided with a temporary stop which can be used to support the second arm part; the second arm part can change the states thereof between the state of being supported by the temporary stop part and the state of being supported by the spring receiving part.

In at least embodiment of the present invention, the energizing member is provided with the first arm part supported by the first lever part and the second arm part supported by the spring receiving part to energize the switch lever to one direction around the axis. Also, the switch lever has a temporary stop part which can be used to support the second arm part; the second arm part can change its state between the state of being supported by the temporary stop and the state of being supported by the spring receiving part. Therefore, during the assembly process of the switch device, the second arm part can change its state from one being supported by the temporary stop part to the other being supported by the spring receiving part at the time of attaching the energizing member to the switch lever to incorporate them together, or after incorporating the energizing member and the switch lever together. Therefore, the energizing member and the switch lever can be efficiently assembled together.

In at least embodiment of the present invention, the energizing member is a torsion coil spring having the first arm part and the second arm part respectively extending from both ends of a wound part arranged around the body part; the torsion coil spring can be configured such that the wound part is kept relaxed in either state in which the second arm part is supported by the temporary stop part or by the spring receiving part.

At least an embodiment of the present invention may adopt a configuration in which the switch lever is provided with a cylindrical part surrounding the wound part from outside in the radial direction, a notch is created in the cylindrical part to extract the first arm part and the second arm part outside of the cylindrical part, and the temporary stop part is a side end portion of the cylindrical part which is opposed to the notch in one direction around the axis.

At least an embodiment of the present invention may adopt a configuration in which the angle θ1 created by the first arm part and the second arm part when the second arm part is supported by the spring receiving part is smaller than the angle θ2 created by the same parts when the second arm part is supported by the temporary stop part. In this case, at least an embodiment of the present invention may adopt a configuration in which the temporary stop part is capable of supporting the second arm part at the same height position in the axial direction as the position of the spring receiving part supporting the second arm part. According to this configuration, for incorporating the switch lever which has the energizing member attached thereto, the switch lever is turned around the axis while keeping the second arm part abutting on the spring receiving part so that the second arm part changes its state from being supported by the temporary stop part to being supported by the spring receiving part. Therefore, the energizing member and the switch lever can efficiently be incorporated.

At least an embodiment of the present invention may adopt a configuration in which the angle θ1 created by the first arm part and the second arm part when the second arm part is supported by the spring receiving part is larger than the angle θ2 created by the same parts when the second arm part is supported by the temporary stop part. In this case, at least an embodiment of the present invention may be configured such that the temporary stop is capable of supporting the second arm part at the height position in the axial direction different from the position of the spring receiving part supporting the second arm part and that the second arm part may be slid along the axial line to move from the state of being supported by the temporary stop part to the state of being supported in the spring receiving part. According to his configuration, when the switch lever having the energizing member attached thereto is mounted first and then the second arm part is slid along the axial line to come off the temporary stop, the second arm part moves to the state of being supported by the spring receiving part. Therefore, the energizing member and the switch lever can efficiently be incorporated.

At least an embodiment of the present invention may adopt a configuration in which the switch is of a push-style.

At least an embodiment of the present invention may adopt a configuration in which the switch lever is equipped with a second lever which extends in the direction crossing the axial direction and the extending direction of the first lever so that the switch changes its state according to the position of the second lever.

An actuator equipped with the switch device of At least an embodiment of the present invention may be configured to have a motor, a rotation transmission mechanism which includes a cam gear having a cam surface to abut on the first lever, and an output member to which the rotation of the motor is transmitted via the rotation transmission mechanism.

A clutch device equipped with the actuator of At least an embodiment of the present invention may be configured to have a clutch member which is driven by the output member to engage/disengage the connection of the mechanism.

A laundry machine equipped with the clutch device of At least an embodiment of the present invention may be configured to have a motor, a tub, a pulsator arranged in the tub, and a driving force transmission mechanism which transmits the rotation driving force of the motor to the tub and the pulsator; the driving force transmission mechanism has the clutch device along the driving force transmission passage between the motor and the tub.

In at least an embodiment the present invention, the energizing member is provided with the first arm part supported by the first lever part and the second arm part supported by the spring receiving part and energizes the switch lever in one direction around the axis. Also, the switch lever is provided with the temporary stop which can be used to support the second arm part, and the second arm part is movable from the state of being supported by the temporary stop to the state of being supported by the spring receiving part. Therefore, when a switch device is assembled, the second arm part can be moved from the state of being supported by the temporary stop to the state of being supported by the spring receiving part at the time of attaching an energizing member to a switch lever and incorporating them, or after an energizing member and a switch lever are incorporated. Therefore, the energizing member and the switch lever can efficiently be incorporated.

### BRIEF DESCRIPTION OF THE DRAWING

Embodiments will now be described, by way of example only, with reference to the accompanying drawings which are meant to be exemplary, not limiting, and wherein like elements are numbered alike in several Figures, in which:

FIG. 1 A cross-sectional view of a configuration of a laundry machine to which At least an embodiment of the present invention is applied.

FIG. 2 A perspective exploded view of a major portion of a driving force transmission mechanism, etc. shown in FIG. 1.

FIG. 3A-FIG. 3B Perspective views of a clutch device to which at least an embodiment of the present invention is applied, viewed obliquely from above.

FIG. 4A-FIG. 4B A perspective view of the clutch device to which at least an embodiment of the present invention is applied, viewed obliquely from below.

FIG. 5 A perspective view of an actuator shown in FIG. 2 and others, viewed from the opposite direction to the protruding direction of a driving pin.

FIG. 6 A perspective exploded view of the actuator shown in FIG. 5.

FIG. 7 An explanatory drawing of a rotation transmission mechanism, etc. shown in FIG. 6.

FIG. 8 A plan view of a switch device shown in FIG. 6.

FIG. 9 A perspective view of the switch device shown in FIG. 8.

FIG. 10 An explanatory drawing of a switch lever and an energizing member of the switch device shown in FIG. 9.

FIG. 11 A perspective exploded view of the switch device shown in FIG. 10.

FIG. 12 A perspective view of the switch lever shown in FIG. 11, viewed from the other side in the axis direction.

FIG. 13 A plan view showing how the switch lever and a torsion coil spring shown in FIG. 14 are incorporated.

FIG. 14 A plan view of a switch device of another embodiment of the present invention.

FIG. 15 A plan view showing how a switch lever and a torsion spring coil shown in FIG. 14 are incorporated.

### DETAILED DESCRIPTION

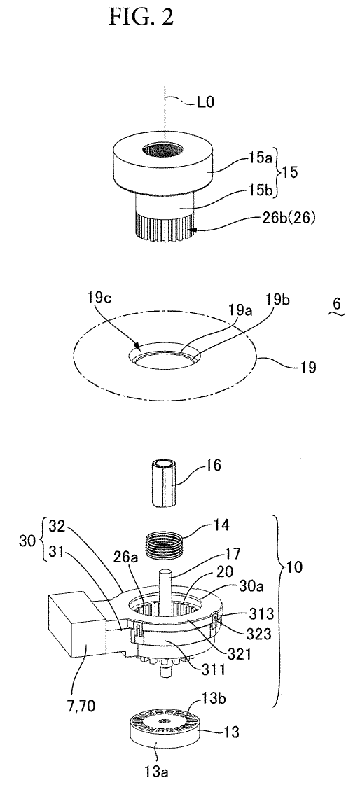

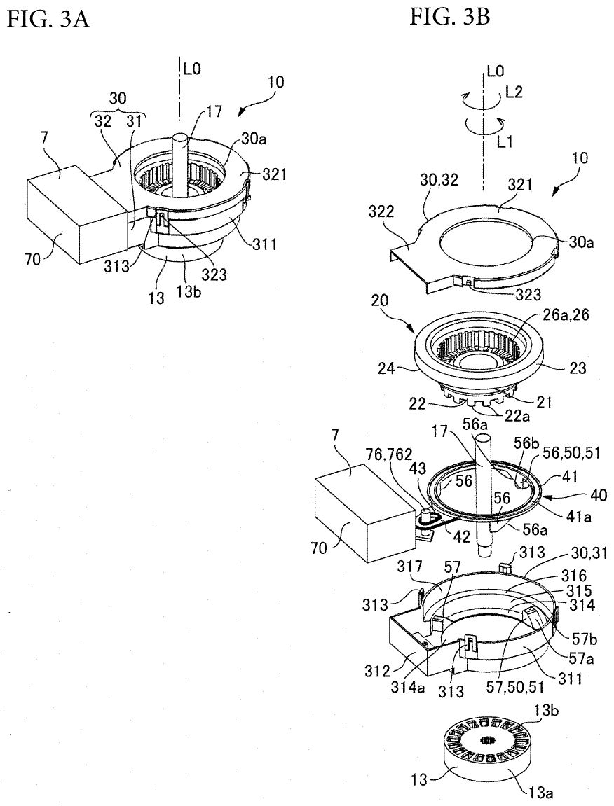

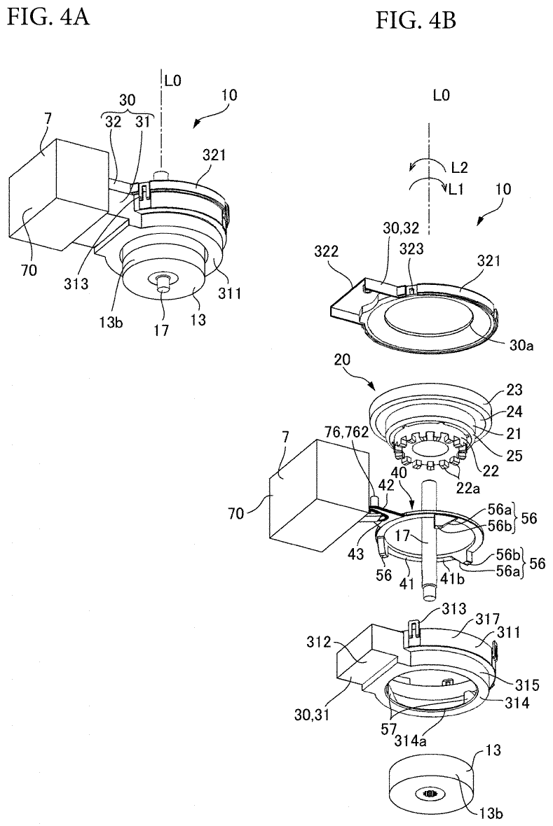

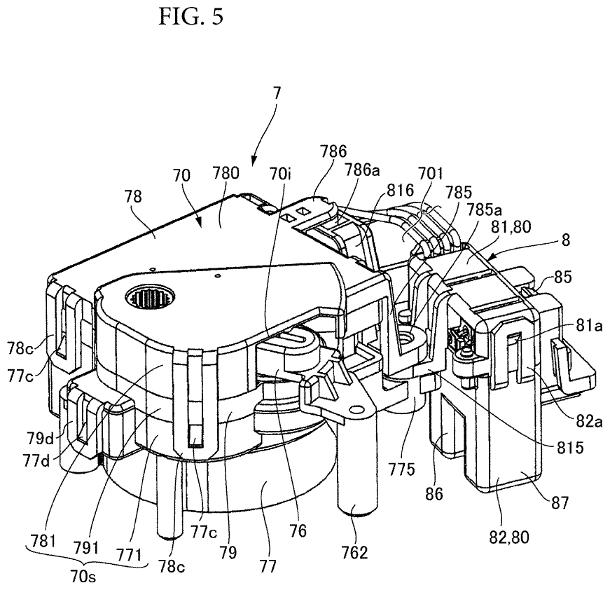

An embodiment of at least an embodiment of the present invention is described hereinafter, based on the drawings. Note that an actuator 7 is schematically shown in a parallelepiped shape in FIG. 2, FIG. 3A-FIG. 3B and FIG. 4A-FIG. 4B, the actual outward form of the actuator 7 is shown in FIG. 5.

### (Overall Configuration)

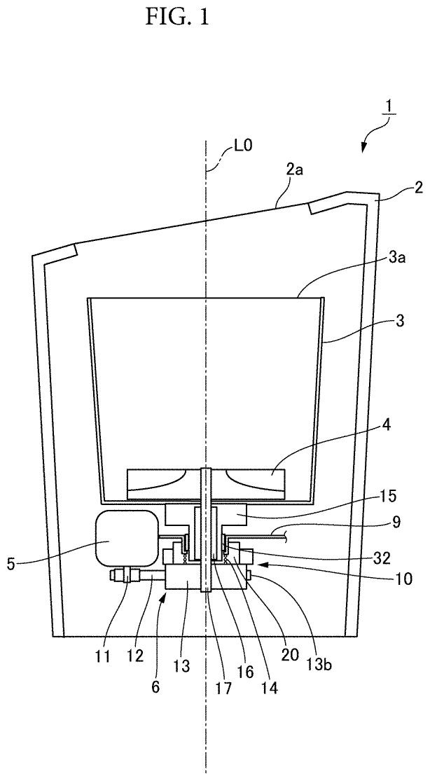

FIG. 1 is a cross-sectional view of a configuration of a laundry machine 1 to which at least an embodiment of the present invention is applied. In the laundry machine 1 shown in FIG. 1, a cylindrical main frame 2 has an opening part 2a on the top surface thereof for putting/taking the laundry clothes in/out; the bottom surface thereof is open. Inside the main frame 2, a cylindrical bottomed wash tub 3 is stored having an opening 3a thereof to face up. The tub 3 is hung on the main frame 2 via a buffer member which is not in the illustration and is capable of rotating around an axis L0. A pulsator 4 is arranged at the bottom of the inside of the wash tub 3.

Below the wash tub 3, a laundry machine motor 5 is arranged. The rotation driving force of the motor 5 is transmitted to the tub 3 and the pulsator 4 via a driving force transmission mechanism 6. The driving force transmission mechanism 6 is equipped with a clutch device 10, which turns on and off the transmission of the rotation driving force of the motor 5 to the tub 3, in the driving force transmission passage between the motor 5 and the tub 3. A sensor is arranged at the bottom of the tub 3 for sensing the rotations of the tub 3; the configuration thereof is described later. The clutch device 10 is supported by the main frame 2 via a support plate 19. While the support plate 19 is of a cup shape, only the bottom portion thereof is shown in FIG. 1 and FIG. 2 which is referred to later.

When the laundry machine 1 having clothes in the washing tub 3 starts operating, water is supplied to the tub 3 via a water supply pipe (no illustration). After that, the motor 5 is driven and the pulsator 4 is rotated to start washing clothes in the tub 3. During the laundry operation, the clutch device 10 is in a state in which the transmission of the rotation driving force of the motor 5 to the tub 3 is disconnected. Therefore, the tub 3 is at a standstill.

When the washing operation is done and the water is drained from the tub 3, a spin-dry operation is performed. In the spin-dry operation, the motor 5 is driven in a transmission connected state in which the rotation driving force of the motor 5 is transmitted to the tub 3. Consequently, the pulsator 4 and the tub 3 rotate together; therefore, the clothes in the tub 3 are spin-dried.

### (Driving Force Transmission Mechanism)

FIG. 2 is a perspective exploded view of a major part of the driving force transmission mechanism 6, etc. shown in FIG. 1. As shown in FIG. 1 and FIG. 2, the driving force transmission mechanism 6 is configured by a first rotor 13 to which the rotation driving force of an output shaft 11 of the motor 5 is transmitted via an endless belt 12, a rotation shaft 17 which is mounted coaxially with the first rotor 13, a coupling member 15 which is coupled coaxially with the bottom portion of the tub 3, and a second rotor 20 which is coupled with the coupling member 15. The first rotor is of a disc shape and arranged below and coaxially with the tub 3. The circular outside circumferential surface of the first rotor 13 is formed as an attaching surface 13a for the endless belt 12 to be attached.

The first rotor 13 has teeth 13b on the top surface thereof. The teeth 13b are formed by multiple protrusions extending in the radial direction at equal angle intervals. The rotation shaft 17 is configured such that the bottom end portion thereof is coupled with the rotator 13 and the top end portion thereof passes through the bottom of the tub 3 and is coupled with the pulsator 4. Therefore, the rotation driving force of the motor 5 is transmitted to the pulsator 4 via the endless belt 12, the first rotor 13 and the rotation shaft 17. In other words, between the motor 5 and the pulsator 4 is formed a driving force transmission passage with the endless belt 12, the first rotor 13 and the rotation shaft 17 arranged therein.

The rotation shaft 17 is arranged inside of a cylindrical member 16. The cylindrical member 16 and the rotation shaft 17 are not connected, but the cylindrical member 16 is rotatable relative to the rotation shaft 17. The outer circumferential side of the cylindrical member 16 is coupled with the coupling member 15 so that the cylindrical member 16 and the coupling member 15 are rotated integrally. The coupling member 15 is configured by, from the top to the bottom in the axis L0 direction, a large diameter flange portion 15a coupled to the tub 3 and a small diameter cylindrical portion 15b having a smaller diameter than the large diameter flange portion 15a. The cylindrical member 16 is inserted into the inside of the small diameter cylindrical portion 15b and is coupled with the small diameter cylindrical portion 15b to co-rotate with the coupling member 15. The second rotor 20 is coaxially coupled on the outer circumferential side at the bottom portion of the small diameter cylindrical portion 15b.

While multiple vertical grooves 26a are formed on the inner circumferential surface of the second rotor 20, multiple protruding lines 26b are formed on the outer circumferential surface of the small diameter cylindrical portion 15b to configure a serration 26 with the vertical grooves 26a. Therefore, the second rotor 20 is coupled with the coupling member 15 by the serration 26 while being relatively movable in the axial direction L0 and being rotatable integrally with the coupling member 15.

A support plate 19 is a member to support the clutch device 10 in a certain position underneath the tub 3 and is hung together with the tub 3 from the main frame 2 via a buffer member (no illustration). A top case 32 is attached to the support plate 19 from the lower side to cover the top of the clutch device 10, and the clutch device 10 becomes supported as the top case 32 is fixed to the support plate 19.

The support plate 19 has an annular protrusion 19b, the center portion of which is made into a through hole 19a so that the small diameter cylindrical portion 15b of the coupling member 15 passes through. The annular protrusion 19b passes through an opening 30a created in a case 30 and protrudes downwardly and the bottom end portion thereof is inserted to the inside of the second rotor 20. Also, a compression coil spring 14 is inserted between the bottom end surface of the annular protrusion 19b and the second rotor 20 to energize the second rotor 20 downwardly (toward the first rotor 13). Further, the top surface of the annular protrusion 19b in the support plate 19 is made to be an annular concave 19c; inside of the concave 19c, an annular bearing (no illustration) is arranged to support the tub 3 to be rotatable from the lower side via the coupling member 15.

### (Configuration of Clutch Device 10)

FIG. 3A-FIG. 3B is a perspective view of the clutch device 10 to which at least an embodiment of the present invention is applied, viewed obliquely from the top side: FIG. 3A and FIG. 3B are respectively a perspective view of the entire clutch device 10 and the perspective exploded view of the same. FIG. 4A-FIG. 4B is a perspective view of the clutch device to which At least an embodiment of the present invention is applied, viewed obliquely from the bottom side: FIG. 4A and FIG. 4B are respectively a perspective view of the entire clutch device 10 and a perspective exploded view of the same.

As shown in FIG. 3A-FIG. 3B and FIG. 4A-FIG. 4B, the clutch device 10 is configured by the second rotor 20 which can engage with the first rotor 13, the clutch member 40 for displacing the second rotor 20, and an actuator 7 which moves the clutch member 40 back and forth between a connecting position to engage the connection between the second rotor 20 and the first rotor 13 in the mechanism and a disconnecting position to disengage the connection between the second rotor 20 and the first rotor 13 in the mechanism. The clutch device 10 is equipped with the compression coil spring 14 shown in FIG. 1 and FIG. 2; the compression coil spring 14 energizes the clutch member 40 downwardly via the second rotor 20. The clutch member 40 has the annular portion 41 and an engagement plate 42 protruding from one position of the annular portion 41 in the circumferential direction; the actuator 7 vibrates the clutch member 40 back and forth around the axis L0 which passes through the center of the annular portion 41.

The clutch device 10 has the case 30 which houses the clutch member 40, etc.; the case 30 is configured by a lower case 31, which covers the clutch member 40, etc. from the bottom side, and an upper case 32, which covers the clutch member 40, etc. from the top side.

The lower case 31 has a cylindrical first case portion 311 and an angular second cover portion 312 protruding from the first case portion 311 outwardly in the radial direction. The upper case 32 has an annular second case portion 321 which aligns with the first case portion 311 of the lower case 31 and an angular second cover portion 322 which protrudes from the second case portion 321 outwardly in the radial direction and aligns with the second cover portion 312 of the lower case 31. The lower case 31 and the upper case 32 are coupled such that an engaging protrusion 313 protruding upwardly from the lower case 31 is engaged with an engaging protrusion 323 formed on the side surface of the upper case 32. In this state, the second rotor 20 and the annular portion 41 of the clutch member 40 are positioned rotatable around the axis L0 between the first case portion 311 and the second case portion 321.

The first case portion 311 of the lower case 31 is configured by an annular bottom plate 314, a cylindrical first body portion 315 protruding upwardly from the outer circumferential edge of the bottom plate 314, and a cylindrical second body portion 317 connected to the first body portion 15 by the top side thereof. The second body portion 317 has a larger diameter than the first body portion 315. For this reason, an annular step portion 316 having a surface facing up is formed along the inner circumferential surface of the first case portion 311 between the first body portion 315 and the second body portion 317.

### (Configuration of Second Rotor 20)

The second rotor 20 has a cylindrical first body portion 21, an annular flange portion 23 having the diameter enlarged at the top portion of the first body portion 21, and a cylindrical second body portion 22 protruding downwardly from the first body portion 21; the multiple vertical grooves 26a which configure the serration 26 are formed on the inner circumferential surface of the first body portion 21. Since the flange portion 23 has a larger diameter than the first body portion 21, an annular first step portion 24 having a surface facing down is formed on the outer circumferential surface of the second rotor 20 between the flange portion 23 and the first body portion 21. This first step portion 24 aligns with the annular bottom plate 314 of the lower case 31 from above via the annular portion 41 of the clutch member 40. Also, the second body portion 22 has a smaller diameter than the first body portion 21; therefore, an annular second step portion 25 having a surface facing down is formed on the outer circumferential surface of the second rotor 20 between the second body portion 22 and the first body portion 21.

The bottom end portion of the second body portion 22 is exposed downwardly (toward the first rotor 13) via a hole 314a formed in the bottom plate 314 of the lower case 31. Also, a teeth portion 22a formed by multiple protruding lines extending in the radial direction at equal angular intervals are provided on the bottom surface of the second body portion 22; the teeth portions 22a can be engaged with the teeth portion 13b of the first rotor 13 when the second rotor 20 is moved downwardly.

Therefore, when the second rotor 20 is moved downwardly in the axis L0 direction and the teeth portion 22a and the teeth portion 13b of the first rotor 13 are engaged with each other, the second rotor 20 and the first rotor 13 coaxially and integrally rotate. Consequently, the rotation driving force of the motor 5 shown in FIG. 1 is transmitted to the tub 3 via the endless belt 12, the first rotor 13, the second rotor 20, and the coupling member 15.

The clutch member 40 is positioned between the lower case 31 and the second rotor 20. The clutch member 40 has an annular portion 41 and an engagement plate 42 protruding from one position in the circumferential direction of the annular portion 41 outwardly in the radial direction; a long hole 43 extending in the radial direction is formed in the engagement plate 42. A driving pin 762 (a working point 76c) formed to the output member 76 of the actuator 7 is fitted to the long hole 43. The annular portion 41 is in the same dimension as the annular bottom plate 314 of the lower case 31 and the annular first step portion 24 of the second rotor 20; the first step portion 24 of the second rotor 20 overlies on the bottom plate 314 of the first case portion 311 of the lower case 31 via the annular portion 41 of the clutch member 40.

While the top surface 41a of the annular portion 41 is made with a flat and smooth surface with no protrusions or recesses, the first step portion 24 of the second rotor 20 is also made with a flat and smooth surface with no protrusions or recesses. Therefore, the top surface 41a of the annular portion 41 and the first step portion 24 of the second rotor 20 overlap with each other by surface-contact.

A guide mechanism 50 is configured between the bottom surface 41b of the annular portion 41 and the bottom plate 314 of the lower case 31 to move the clutch member 40 between the connecting position and the disconnecting position, which are described later when the clutch member 40 has rotated around the axis L0 passing the center of the annular portion 41. In this embodiment, when the clutch member 40 has rotated around the axis L0 passing through the center of the annular portion 41, the clutch member 40 is also moved along the axis L0 direction to move between the connecting position and the disconnecting position. For this reason, the guide mechanism 50 configured between the bottom surface 41b of the annular portion 41 and the annular bottom plate 314 of the lower case 31 is equipped with a cam mechanism 51.

The cam mechanism 51 has a first protrusion 56 protruding downwardly with the inclined surface 56a facing in one direction L1 around the axis L0 under the bottom surface 41b of the annular portion 41 of the clutch member 40; the first protrusion 56 has a flat bottom end surface 56b, which perpendicularly intersects with the axis L0, adjacent to the inclined surface 56a on the other side L2 around the axis L0. In this embodiment, the first protrusion 56 is formed at three positions in the circumferential direction; the portion in the bottom surface 41b at which the first protrusion 56 is not formed is made a flat surface intersecting perpendicularly with the axis L0.

The cam mechanism 51 also has a second protrusion 57 protruding upwardly with an inclined surface 57a (a first cam surface) facing in the other direction L2 around the axis L0 on the top surface of the bottom plate 314 of the lower case 31; the second protrusion 57 has a flat top end surface 57b (a second cam surface), which perpendicularly intersects with the axis L0, adjacent to the inclined surface 57a on one side L1 around the axis L0. In this embodiment, the second protrusion 57 is formed at three positions in the circumferential direction; the portion in the top surface of the bottom plate 314 at which the first protrusion 57 is not formed is made a flat surface (a third cam surface) intersecting perpendicularly with the axis L0.

Therefore, when the clutch member 40 is driven by the driving pin 762 of the actuator 7 to rotate in one direction around the axis L0, the first protrusions 56 of the clutch member 40 move over the inclined surfaces 57a of the second protrusions 57 formed on the bottom surface 314 of the lower case 31 and [consequently,] the first protrusions 56 overlay on the top end surface 57b of the second protrusion 57. As a result, the clutch member 40 pushes the second rotor 20 upwardly against the emerging force of the compression coil spring 14 shown in FIG. 1. For this reason, the teeth portion 22a of the second rotor 20 and the teeth portion 13b of the first rotor 13 in the mechanism are disengaged, and therefore, the connection between the second rotor 20 and the first rotor 13 in the mechanism is disengaged. Consequently, even if the first rotor 13 is rotated, the second rotor 20 is not, and therefore, while the pulsator 4 shown in FIG. 1 rotates, the tub 3 does not.

When, from the above state, the clutch member 40 is driven by the driving pin 762 of the actuator 7 and rotated in the other direction L2 around the axis L0, the first protrusion 56 moves down on the inclined surface 57a of the second protrusion 57 formed on the bottom plate 314 of the lower case 31. As a result, the clutch member 40 and the second rotor 20 move downwardly with the energizing force of the compression coil spring 14 shown in FIG. 1. Accordingly, the teeth portion 22a and the teeth portion 13b of the first rotor 13 are engaged with each other; thus, the connection between the second rotor 20 and the first rotor 13 in the mechanism is engaged. Therefore, when the first rotor 13 rotates, the second rotor 20 also rotates, and the pulsator 4 and the tub 3 shown in FIG. 1 both rotate.

### (Overall Configuration of Actuator 7)

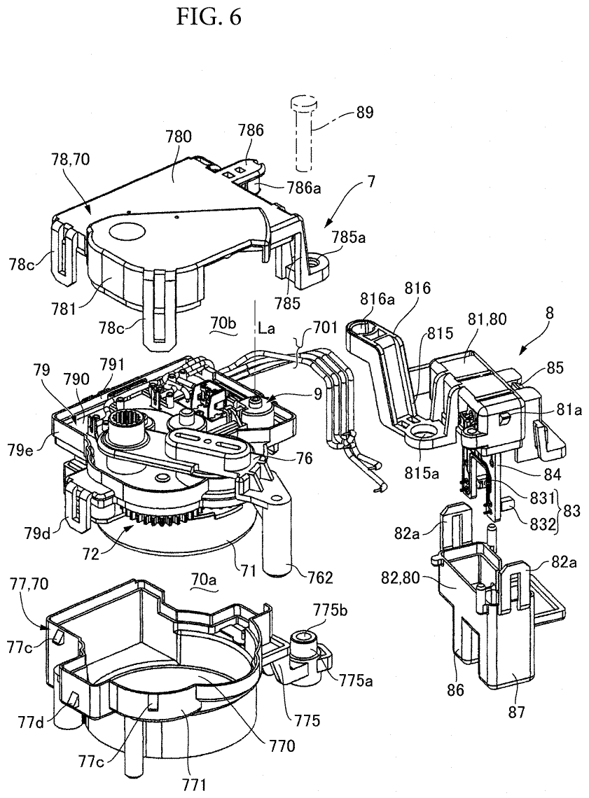

FIG. 5 is a perspective view of the actuator 7 shown in FIG. 2, etc., viewed from the opposite side from the protruding direction of the driving pin 762. FIG. 6 is a perspective exploded view of the actuator 7 shown in FIG. 5. Note that in the actuator 7, the driving pin 762 is configured to protrude either upwardly or downwardly. In this configuration, the driving pin 762 is configured to protrude upwardly as shown in FIG. 3A-FIG. 3B and FIG. 4A-FIG. 4B; however, the actuator 7 is vertically inverted and the driving pin 76 protrudes downwardly in FIG. 5 and FIG. 6 to explain the configuration of the actuator 7.

As shown in FIG. 5 and FIG. 6, the actuator 7 has an exterior case 70 and an output member 76, the leading end of which protrudes as the driving pin 762 from the exterior case 70. The actuator 7 also has a plate-like support member 79, a first case member 77 which covers one side of the support member 79 to create a first space 70a, and a second case member 78 which covers the other side of the support member 79 to create a second space 70b; the exterior case 70 is configured by the first case member 77 and the second case member 78.

The first case member 77 is configured by an end plate portion 770 facing the support member 79, a side plate portion 771 which protrudes from the edge of the end plate portion 770 toward the second case member 78. The second case member 78 is configured by an end plate portion 780 facing the support member 79 and a side plate portion 781 which protrudes from the edge of the end plate portion 780 toward the first case member 77. The support member 79 has a bottom plate portion 790 and a side plate portion 791 which is provided around the edge of the bottom plate portion 790; the side plate portion 791 of the support member 79 is held between the side plate portion 771 of the first case member 77 and the side plate portion 781 of the second case member 78, together configuring a side surface 70s of the exterior case 70.

The second case member 78 has engagement protrusions 78c formed thereto, which protrude toward the first case member 77; the side plate portion 771 of the first case 77 has engagement protrusions 77c formed thereto, which engage with the engagement protrusions 78c. An engagement protrusion 79d protruding toward the first case member 77 is formed on the support member 79, and an engagement protrusion 77d is formed on the side plate portion 771 of the first case member 77 to be engaged with the engagement protrusion 79d. Although the illustration is omitted, an engagement protrusion protruding toward the support member 79 is formed on the second case member 78. Therefore, the first case member 77, the support member 79 and the second case member 78 can fasten one another.

### (Configuration of Sensor Unit 8)

As shown in FIG. 5 and FIG. 6, a sensor unit 8 is arranged on a side of the exterior case 70. The sensor unit 8 has a cover 80 configured by a first cover member 81 and a second cover member 82. Engagement protrusions 82a protruding toward the first cover member 81 are formed to the second cover member 82; engagement protrusions 81a are formed on the first cover member 81 to be engaged with the engagement protrusions 82a. Therefore, the first cover member 81 and the second cover member 82 are aligned and coupled with each other.

A wiring board 84 is arranged inside the cover 80. A wiring member 701 composed of a lead wire is pulled from the actuator 7 and electrically connected to the wiring board 84. A connector 85 and a sensor 83 are mounted on the wiring board 84; the connector 85 is exposed from the first cover member 81 to the outside. Therefore, a power is supplied to the actuator 7 and signals from the switch device 9 or the sensor 83 are output via the connector 8.

The sensor 83 is a photo interrupter equipped with a light-emitting element 831 and light-receiving element 832 and is used for sensing rotations of the tub 3 and pulsator 4. The second cover member 82 has a first protrusion 86 projecting oppositely from the first cover member 81 and a second protrusion 87 which faces the first protrusion 86; the light-emitting element 831 and the light-receiving element 832 are arranged inside of the first protrusion 86 and the second protrusion 87, facing each other. Therefore, if a cylindrical part with a slit, which rotates integrally with the tub 3 and the pulsator 4, is arranged between the first protrusion 86 and the second protrusion 87, the rotations of the cylindrical part can be detected.

### (Coupling Structure of Actuator 7 and Sensor Unit 8)

In the actuator 7, a first coupling portion 775 having a cylindrical part 775a at the front end thereof protrudes from the first case member 77, and a second coupling part 785 having a hole 785a at the front end thereof protrudes from the second case member 78. Also, a shaft part 785a provided to a protrusion portion 786 of the second case member 78 protrudes toward the first case member 77. In the sensor unit 8, a third coupling portion 815 having a hole 815a at the middle point thereof protrudes from the first cover member 81. The end piece 816 of the third coupling part 815 is bent at the position where the hole 815a is formed and extended toward the second case member 78; a hole 816a is formed in the tip of the end piece 816.

When the first case member 77 and the second case member 78 are coupled interposing the support member 79 between them, the hole 785a in the second coupling part 785 aligns with the hole 775b in the cylindrical portion 775a of the first coupling part 775. Therefore, the actuator 7 and the sensor unit 8 can be coupled by fitting a shaft part 786a of the second case ember 78 into the hole 815a of the third coupling part 815, positioning the third coupling part 815 between the first coupling part 775 and the second coupling part 785 such that the hole 815a of the third coupling part 815 aligns with the hole 775b of the cylindrical part 775a and the hole 785a of the second coupling part 785, and then fastening a screw 89 into the holes 785a, 815a and 775b. As the screw 89 is fastened to the laundry machine 1, the actuator 7 and the sensor unit 8 are fastened to the laundry machine 1.

### (Configuration of the Inside of the First Space 70a)

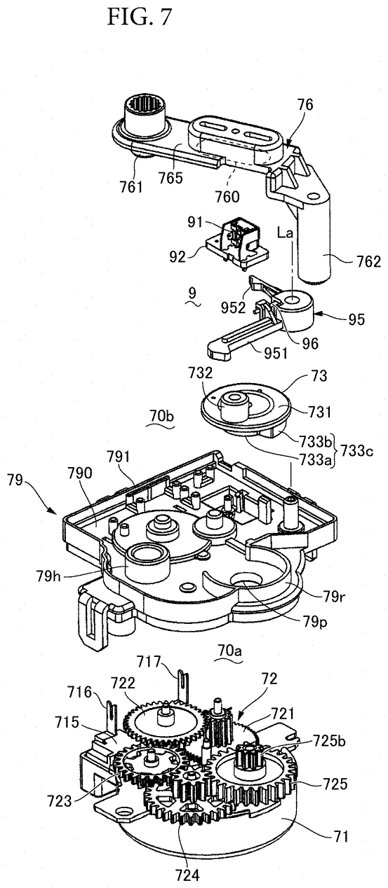

FIG. 7 is an explanatory diagram of the rotation transmission mechanism 72 shown in FIG. 6. As shown in FIG. 6 and FIG. 7, a clutch motor 71 and the rotation transmission mechanism 72 are arranged in the first space 70a sectioned by the first case member 77 and the support member 79. The clutch motor 71 is a synchronous motor and is capable of rotating in only one direction. A terminal stand 715 is provided on the clutch motor 71 to hold terminals 716 and 717.

The rotation transmission mechanism 72 is configured by a first gear 721 which meshes with a motor pinion (not in the illustration), a second gear 722 which meshes with the first gear 721, a third gear 723 which meshes with the second gear 722, a fourth gear 724 which meshes with the third gear 723, and a fifth gear 725 which meshes with the fourth gear 724. The first gear 721, the second gear 722, the third gear 723 and the fourth gear 724 are all composite gears in which a small diameter gear and a large diameter gear are integrally formed. The rotation transmission mechanism 72 reduces the rotation speed of the clutch motor 71 and transmits it to the fifth gear 725. The gear-shaped small diameter part 725b of the fifth gear 725 protrudes into a second space 70b via a hole 79p which is created inside a cylindrical wall portion 79r of the support member 79.

### (Configuration of the Inside of the Second Space 70b)

Inside the second space 70b sectioned by the support member 79 and the second case member 78 are arranged a base end of the output member 76, the cam gear 73, the switch device 9, etc.

The cam gear 73 has a disc part 731 and a cylindrical body part 733 protruding from the disc part 731 toward the support member 79; a gear-shaped recess part is formed on the inner circumferential surface of the body part 733 to mesh with the small diameter part 725b of the fifth gear 725. Therefore, the rotation of the clutch motor 71 is transmitted to the cam gear 73 via the rotation transmission mechanism 72. In the cam gear 73, the disc part 731 is provided with an eccentric pin 732, which protrudes from the disc part 731 in the opposite direction from the support member 79, at the position away from the rotation center axis of the cam gear 73.

The output member 76 has an extension 765, the tip end of which protrudes to the outside the exterior case 70, and a driving pin 762 which protrudes from the extension 765 in the direction perpendicularly intersecting with the extending direction of the extension 765. The end portion of the output member 76 passes through an opening 70i (referring to FIG. 5) created in the second case member 78, protrudes outside of the exterior case 70 and is fitted into the long hole 43 in the clutch member 40, which is described referring to FIG. 4A-FIG. 4B, etc.

An elongated hole 760 is formed in the extension 765 of the output member 76 so that the eccentric pin 732 of the cam gear 73 is fitted therein. Also, a shaft part 761 is formed in the base end of the output member 76; the shaft part 761 is rotatably fitted inside of a cylindrical part 79h created in the support member 79. Therefore, when the clutch motor 71 rotates and the cam gear 73 rotates, the output member 76 oscillates centering about the shaft part 761 to rotate the clutch member 40 shown in FIG. 3A-FIG. 3B and FIG. 4A-FIG. 4B around the axis L0. As the cam gear 73 further rotates, the output member 76 oscillates in the reverse direction centering around the shaft part 761 to rotate the clutch member 40 in the reverse direction around the axis L0 so that the connection [between the second rotor 20 and the first rotor 13] in the mechanism is engaged/disengaged.

### (Configuration of Switch Device 9)

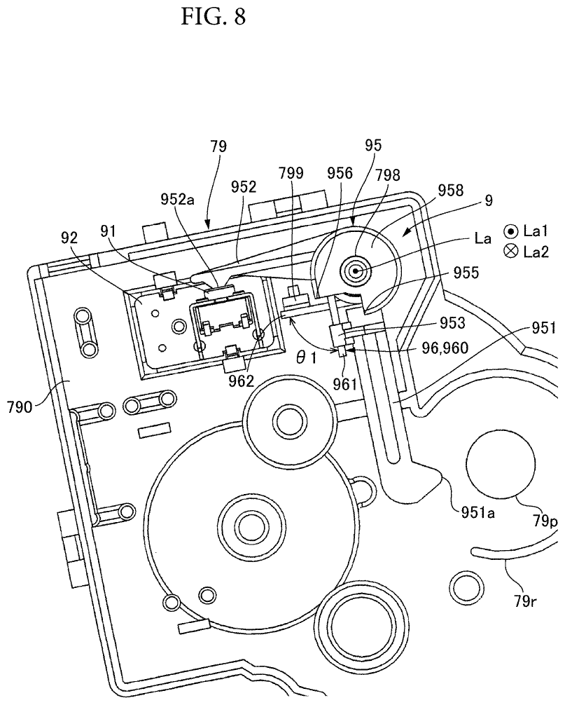

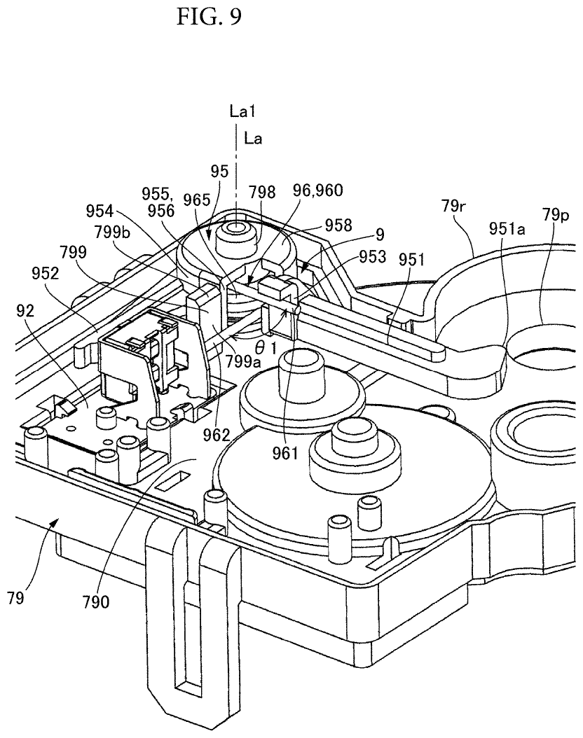

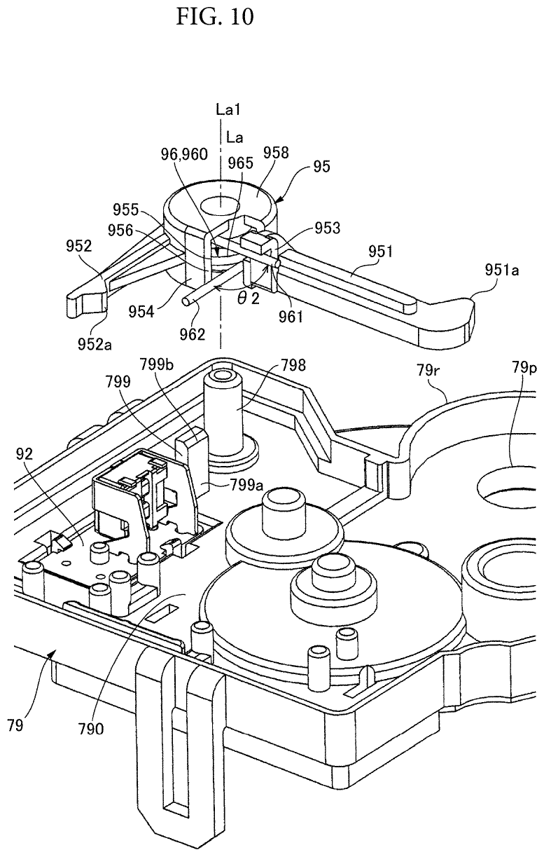

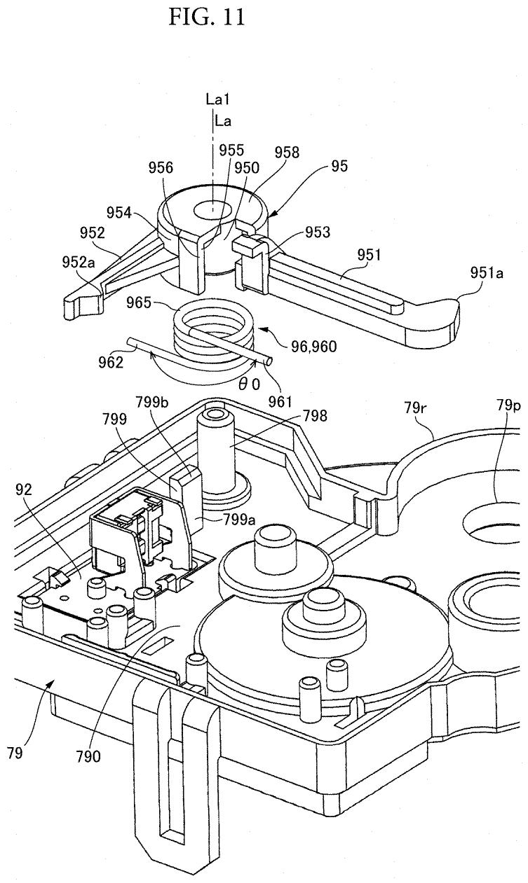

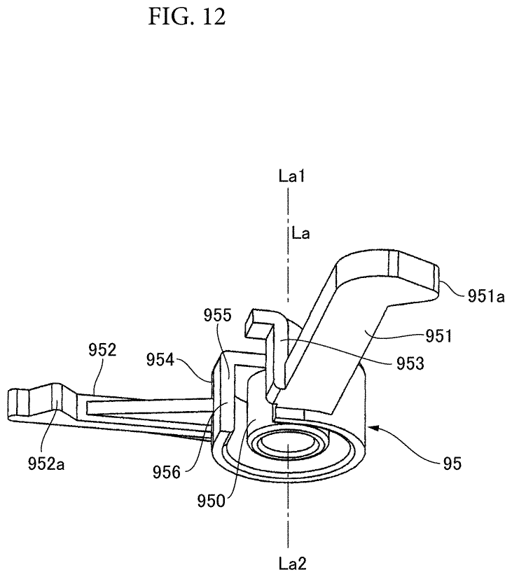

FIG. 8 is a plan view of the switch device 9 shown in FIG. 6. FIG. 9 is a perspective view of the switch device 9 shown in FIG. 9. FIG. 10 is an explanatory diagram of a switch lever 95 and an energizing member 96 of the switch device 9. FIG. 11 is a perspective exploded view of the switch device 9 shown in FIG. 10. FIG. 12 is a perspective view of the switch lever 95, viewed from the other side La2 in the axis La direction.

As shown in FIG. 8, FIG. 9, FIG. 10 and FIG. 11, the switch device 9 has the support member 79 equipped with a lever supporting part 798 and a spring receiving part 799, a switch lever 95 supported to rotate around the axis La by the lever supporting part 798, the energizing member 96 for energizing the switch lever 95 in one direction CCW around the axis La, and a switch 91 which switches the state thereof according to the position of the switch lever 95; the switch lever 95 interlocks with the output shaft 76 and rotates around the axis La. In this embodiment, the lever supporting part 798 is a shaft part protruding from the bottom plate portion 790 of the support member 79 toward one side La1 in the axis La direction; the switch lever 95 is provided with a cylindrical body part 950 fitted to the lever supporting part 798.

In this embodiment, the outer circumferential surface of the body portion 733 of the cam gear 73 shown in FIG. 7 is a cam surface 733c which is configured by the small diameter portion 733a and the large diameter portion 733b in the circumferential direction; the switch lever 95 has a first lever part 951 which extends from the body part 950 in the direction crossing the axial line La and abuts on the cam surface 733c with the tip end 951a thereof. Since the switch lever 95 is energized in one direction CWW around the axis La by the energizing member 96, the tip end 951a of the first lever part 951 is energized to abut on the cam surface 933c.

The switch lever 95 also has a second lever part 952 which extends from the body part 950 in the direction crossing the axis L1 direction and the direction in which the first level 951 extends; the switch 91 switches the state thereof according to the position of the second lever part 952. More specifically described, the switch 91 is a push-type switch mounted on the substrate 92; FIG. 8 and FIG. 9 show the ON state in which the tip end 951a of the first lever part 951 abuts on the small diameter portion 733a of the cam surface 733c and a tip end 952a of the second lever part 952 presses the switch 91. When the cam gear 73 rotates in the ON state and abuts on the large diameter portion 733b of the cam surface 733c, the switch lever 95 rotates in the reverse direction CW around the axis La; therefore, the tip end 952a of the second lever part 952 separates from the switch 91 to be in the OFF state. Thus, the connection/disconnection between the teeth portion 22a of the second rotor 20 and the teeth portion 13b of the first rotor 13 shown in FIG. 3A-FIG. 3B can be monitored, based on the output from the switch 91.

In this embodiment, the energizing member 96 is a torsion coil spring 960 in which a first arm part 961 and a second arm part 962 protrude respectively from both ends of a wound part 965 arranged around the body part 950 of the switch lever 95; the first arm part 961 is supported by the first lever part 951 and the second arm part 962 is supported by the spring receiving part 799.

More specifically described, the spring receiving part 799 is a plate-like part protruding from the bottom plate portion 790 of the support member 79 toward one side La1 in the axis La direction; the second arm part 962 abuts resiliently with the energizing force of the torsion coil spring 960 on the receiving surface 799a of the spring receiving part 799 which faces one direction CCW around the axis La. In this embodiment, the tip portion of the receiving surface 799a is formed into an inclined surface 799b.

The first lever part 951 is provided with a plate-like engagement part 953, which protrudes toward one side La1 in the axial line La, at the end portion thereof in the other direction CW around the axis La; the first arm part 961 abuts resiliently on the engagement part 953 from the other direction CW around the axis La. Therefore, the first arm part 961 energizes the switch lever 95 in one direction CWW around the axis La. In this embodiment, the engagement part 953 is configured such that the tip end portion thereof is bent in the other direction CW around the axis La.

In this embodiment, the torsion coil spring 960 is configured as shown in FIG. 11 such that the angle θ0 created by the first arm part 961 and the second arm part 962 in an independent state where there is no external force applied is 180°. On the other hand, in a state where the coil spring 960 is incorporated in the switch device 9 as shown in FIG. 8 and FIG. 9, the second arm part 962 is moved in the direction in which the wound part 965 becomes relaxed and the angle θ1 thereof created with the first arm part 961 is 90°.

### (Configuration of Temporary Stop Part 956)

In the switch device 9 as configured as above, a temporary stop part 956 which can support the second arm part 962 is provided in the switch lever 95 as shown in FIG. 10. More specifically described, as shown in FIG. 11 and FIG. 12, a cylindrical part 954 is provided to the switch lever 95 to surround the wound part 965 of the torsion coil spring 960 from outside in the radial direction; a notch 955 is formed in the cylindrical part 954 to let the first arm part 961 and the second arm part 962 out of the cylindrical part 954. Therefore, the side end portion of the cylindrical part 954 facing the notch 955 in one direction CCW around the axis La configures the temporary stop part 956 which can support the second arm part 962. The temporary stop part 956 extends in a straight line along the axis La to both ends in the axial La direction of the cylindrical part 956. Therefore, the temporary stop part 956 can support the second arm part 962 at the same height position in the axial La direction as the support position of the spring receiving part 799 for the second arm part 962.

In the state where the second arm part 962 is in abutment on the temporary stop part 956, the wound part 965 is relaxed. Therefore, the second arm part 962 is in abutment while being energized by the energizing force of the torsion coil spring 960 itself in the other direction CW around the axis La; the torsion coil spring 960 is held in the switch lever 95 in the state which is shown in FIG. 10.

The switch lever 95 is provided with an annular end plate 958 at the end portion thereof on one side La in the axis La direction to connect the body part 950 and the cylindrical portion 95; therefore, [a space] between the body part 950 and the cylindrical portion 954 is covered by the end plate 958. On the other hand, [a space] between the body part 950 and the cylindrical portion 954 at the end portion on the other side L2 in the axis La is in an open state. For this reason, the wound part 965 of the torsion coil spring 960 is fitted into the space between the body part 950 and the cylindrical portion 954 from the other side La2 in the axis La direction.

In this embodiment, the angle θ1 created by the first arm part 961 and the second arm part 962 when the second arm part 962 is supported by the spring receiving part 799 is smaller than the angle θ2 created by the same when the second arm part 962 is supported by the temporary stop part 956. For example, the angle θ2 created by the first arm part 961 and the second arm part 962 when the second arm part 962 is supported by the temporary stop part 956 is about 100°.

In the switch lever 95 and the torsion coil spring 960 as configured above, the second arm part 962 can move from the state of being supported by the temporary stop part 956 to the state of being supported by the spring receiving part 799, as described below.

(Method of Incorporating Switch lever 95 and Torsion Coil Spring 960)

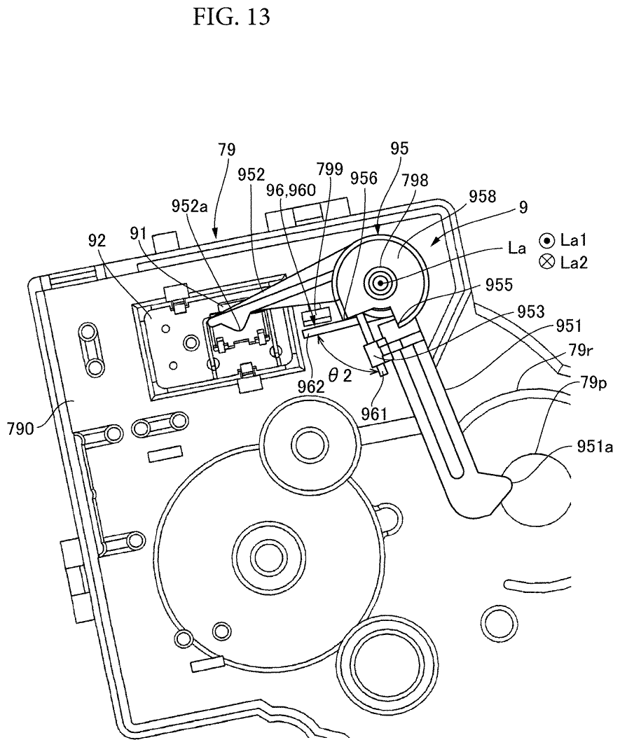

FIG. 13 is a plan view showing a method of incorporating the switch lever 95 and the torsion coil spring 960 shown in FIG. 8. In the step of incorporating the switch lever 95 and the torsion coil spring 960 in a manufacturing process of the actuator 7 of this embodiment, the wound part 965 of the torsion coil spring 960 is fitted into the body part 950 of the switch lever 95 from the other side La2 in the axis La direction, as shown in FIG. 10 and FIG. 13. At that time, while the first arm part 961 and the second arm part 962 are moved in the directions so that the wound part 965 is relaxed and the first arm part 961 is made to abut on the engagement part 953 provided in the first lever part 951, the second arm part 962 is made to abut on the temporary stop part 956; thus, the torsion coil spring 960 is held in the switch lever 95.

Next, as shown in FIG. 13, the body part 950 of the switch lever 95 is fitted to the lever supporting part 798 such that the tip end portion of the second arm 962 is positioned on the side of one direction CCW around the axis La with respect to the spring receiving part 799. Next, while being pushed to the other side La2 in the axis La direction, the switch lever 95 is rotated in the other direction CW around the axis La. Consequently, as shown in FIG. 8, the second arm 962, after abutting on the spring receiving part 799, is separated from the temporary stop part 956 and is moved to the state of being supported by the spring receiving part 799. At that time, the position of the second arm part 962 in the axis La direction does not change greatly; therefore, the position of the temporary stop part 962 supporting the second arm part 962 and the position of the spring receiving part 799 supporting the second arm part 962 are at the same or almost the same height in the axis La direction.

Then, when the cam gear 73 shown in FIG. 7 is mounted and the tip end 951a of the first lever part 951 of the switch lever 95 is made to abut on the cam surface 733c of the cam gear 73, the switch lever 95 is now incorporated while the angle position thereof around the axis La is fixed.

(Major Effects of this Embodiment)

As described above, in the switch device 9 of this embodiment, the energizing member 96 is provided with the first arm part 961 which is supported by the first lever part 951 of the switch lever 95 and the second arm part 962 which is supported by the spring receiving part 799 of the support member 79 to energize the switch lever 95 in one direction CCW around the axial La. Also, the temporary stop part 956 is provided to the switch lever 95 to support the second arm part 962; the second arm part 962 can move from the state of being supported by the temporary stop part 956 to the state of being supported by the spring receiving part 799. For this reason, in the assembly process of the switch device 9, the second arm part 962 can be moved from the state of being supported by the temporary stop part 956 to the state of being supported by the spring receiving part 799 at the time of attaching and incorporating the energizing member 96 to the switch lever 95, or after the energizing member 96 and the switch lever 95 are incorporated. Thus, the energizing member 96 and the switch lever 95 can efficiently be incorporated.

In this embodiment, the energizing member is the torsion coil spring 960; the torsion coil spring 960 is configured such that the wound part 965 is relaxed in either state of the second arm part 962 being supported by the temporary stop part 956 or by the spring receiving part 799. Although the torsion coil spring 960 has an advantage that the energizing member 96 can be arranged in a narrow space, it takes time and effort to have the first arm part 961 and the second arm part 962 of the torsion coil spring 960 supported respectively by the engaging part 953 of the switch lever 95 and the spring receiving part 799 of the support member 79; however, according to this embodiment, even when the energizing member 96 is the torsion coil spring 960, the energizing member 96 (the torsion coil spring 960) and the switch lever 95 can efficiently be incorporated.

In this embodiment, also, the angle θ1 created by the first arm part 961 and the second arm part 962 when the second arm part 962 is supported by the spring receiving part 799 is smaller than the angle θ2 created by the same when the second arm part 962 is supported by the temporary stop part 956. Therefore, to incorporate the switch lever 95 in which the torsion coil spring 960 has already been attached, the second arm part 962 can be moved from the state of being supported by the temporary stop part 956 to the state of being supported by the spring receiving part 799 by rotating the switch lever 95 to make the second arm part 962 abut on the spring receiving part 799. Thus, the energizing member 96 and the switch lever 95 can efficiently be incorporated.

### Another Embodiment

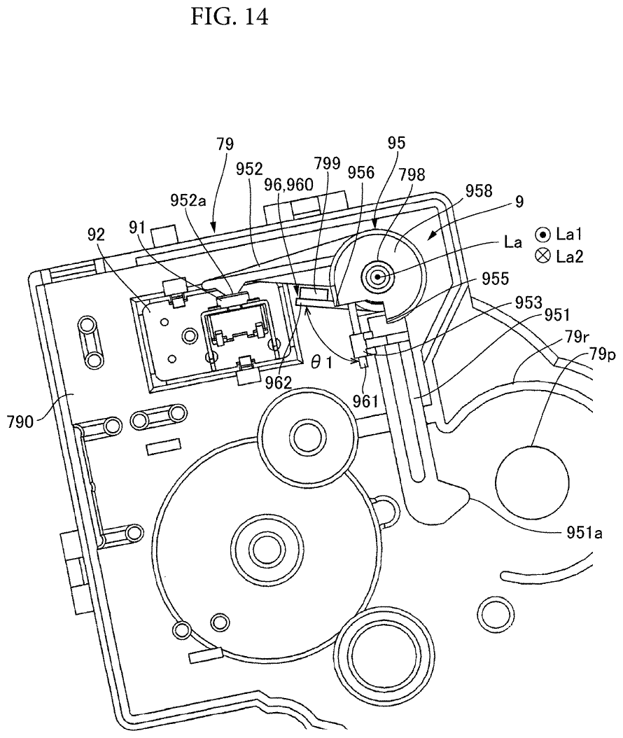

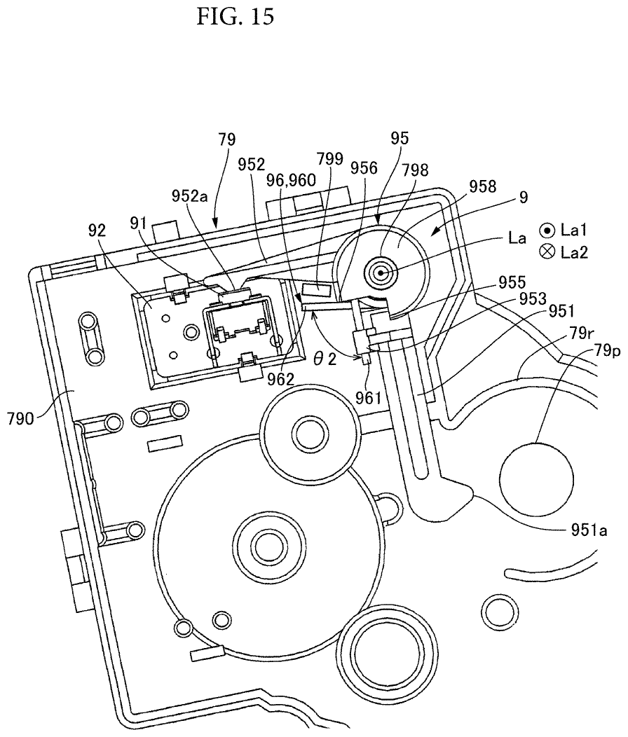

FIG. 14 is a plan view of the switch device 9 of another embodiment of the present invention. FIG. 15 is a plan view to show the method of incorporating the switch lever 95 and the torsion coil spring 960. Note that the basic configuration of this embodiment is the same as that of the embodiment which is described referring to FIG. 8; therefore, the same codes are used for the common parts and their descriptions are omitted.

As shown in FIG. 14, the switch device 96 of this embodiment has the support member 79 configured by the lever supporting part 798 and the spring receiving part 799, the switch lever 95 which is supported by the lever supporting part 798 to rotate around the axis La, the energizing member 96 which energizes the switch lever 95 in one direction CCW around the axis La, and the switch 91 which switches the state thereof according to the position of the switch lever 95. As shown in FIG. 15, the switch lever 95 is provided with the temporary stop part 956 which can support the second arm part 962.

In this embodiment, the spring receiving part 799 is positioned more on the other direction CW around the axis La than that of the embodiment described referring to FIG. 8. Therefore, the angle θ1 created by the first arm part 961 and the second arm part 962 when the second arm part 962 is supported by the spring receiving part 799 as shown in FIG. 14 is larger than the angle θ2 created by the same when the second arm part 962 is supported by the temporary stop part 956 as shown in FIG. 15. For example, the angle θ1 created by the first arm part 961 and the second arm part 962 when the second arm part 962 is supported by the spring receiving part 799 is about 120° while the angle θ2 created by the same created when the second arm part 962 is supported by the temporary stop part 956 is about 100°.

In the switch lever 95 and the torsion coil spring 960 configured as above, the second arm part 962 can be moved from the state of being supported by the temporary stop part 956 to the state of being supported by the spring receiving part 799 as in the following description. In other words, in the step of incorporating the switch lever 95 and the torsion coil spring 960 in the manufacturing process of the actuator 7, the wound part 965 of the torsion coil spring 960 is fitted to the body part 950 of the switch lever 95 from the other side La2 in the axis La direction, as shown in FIG. 15. At that time, the first arm part 961 and the second arm part 962 are moved in the directions so that the wound part 965 is relaxed to make the first arm part 961 abut on the engagement part 953 provided to the first lever 951 and to make the second arm part 962 abut on the temporary stop part 956; thus, the torsion coil spring 960 is held by the switch lever 95.

Next, the body part 950 of the switch lever 95 is fitted to the lever supporting part 798, and then the second arm part 962 is slid along the temporary stop part 956 toward the other side La2 in the axis La. Consequently, the second arm part 962 comes off the temporary stop part 956 and moves to the state of being supported by the spring receiving part 799. Therefore, the supporting position of the temporary stop part 956 for the second arm part 962 is shifted from the supporting position of the spring receiving part 956 for the second arm portion 962 in the axis La direction.

After this, when the cam gear 73 shown in FIG. 7 is incorporated and the tip end 951a of the first lever 951 of the switch lever 95 abuts on the cam surface 733c of the cam gear 73, the switch lever 95 is incorporated with the angle position thereof around the axis La fixed.

According to this configuration, to assemble the switch device 9, the energizing member 96 is first attached to the switch lever 95 and the energizing member 96 and the switch lever 95 are incorporated, and then, the second arm part 962 can be moved from the state of being supported by the temporary stop part 956 to the state of being supported by the spring receiving part 799. Therefore, the energizing member 96 and the switch lever 95 can be efficiently incorporated, demonstrating the same effect as the embodiment described referring to FIG. 8.

### Another Embodiment

In the above-described embodiment, the energizing member 96 is the torsion coil spring 960; however, at least an embodiment of the present invention may be applied in a configuration in which the energizing member 96 is a sheet spring curved in a U-shape between the first end portion and the second end portion.

In the above-described embodiment, the driving pin 762 of the output member 76 is fitted in the long hole 43 in the clutch member 40; however, at least an embodiment of the present invention may adopt a configuration in which the engaging pin provided to the clutch member 40 is fitted to the elongated hole provided to the output member 76. In the above-described embodiment, the rotation of the clutch motor 71 is transmitted to the output member 76 as the rotating motion of the eccentric pin 732 of the cam gear 73; however, at least an embodiment of the present invention may be applied to the case in which the rotating motion of the clutch motor 71 is converted to a linear motion and transmitted to the output member 76. In the above-described embodiment, the actuator 7 is arranged with the driving pin 762 facing up (toward the tub 3); however, the actuator 7 may be arranged with the driving pin 762 facing down (toward the opposite from the tub 3).

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

### DESCRIPTION OF REFERENCE NUMERALS

1 Laundry machine
3 Tub
4 Pulsator
5 Laundry machine motor
6 Driving force transmission mechanism
7 Actuator
8 Sensor unit
9 Switch device
10 Clutch device
40 Clutch member
51 Cam mechanism
70a First space
70b Second space
71 Clutch motor
72 Rotation transmission mechanism
73 Cam gear
76 Output member
77 First case member
78 Second case member
79 Support member
83 Sensor
91 Switch
95 Switch lever
96 Energizing member
732 Eccentric pin
950 Body part
733c Cam surface
762 Driving pin
798 Lever supporting part
799 Spring receiving part
951 First lever
952 Second lever
953 Engagement part
955 Notch
956 Temporary stop part
960 Torsion coil spring
961 First arm part
962 Second arm part
965 Wound part
La Axis

What is claimed is:

1. A switch device comprising:
a support member provided with a lever supporting part and a spring receiving part;
a switch lever having a body part, which is supported by said lever supporting part to rotate around an axis, and a first lever part which extends from said body part in a direction crossing said axis;
an energizing member which is provided with a first arm part supported by said first lever and a second arm part supported by said spring receiving part to energize said switch lever in one direction around said axis; and
a switch which switches the status thereof depending on the position of said switch lever;
wherein a temporary stop part capable of supporting said second arm part is formed to said switch lever; said second arm part can move from a state of being supported by said temporary stop part to a state of being supported by said spring receiving part.

2. The switch device as set forth in claim 1, wherein
said energizing member is a torsion coil spring having said first arm part and said second arm part which extend from both ends of a wound part arranged around said body part; and
said torsion coil spring is structured such that said wound part is relaxed either in the state in which said second arm part is supported by said temporary stop part or in the state in which said second arm part is supported by said spring receiving part.

3. The switch device as set forth in claim 2, wherein
said switch lever is provided with a cylindrical part which surrounds said wound part from outside in the radial direction;
a notch is formed in said cylindrical part to let said first arm part and said second arm part outside of said cylindrical part; and
said temporary stop part is a side end portion facing said notch in one direction around said axis.

4. The switch device as set forth in claim 2, wherein
the angle θ1 created by said first arm part and said second arm part when said arm part is supported by said spring receiving part is smaller than the angle θ2 created by the same when said second arm part is supported by said temporary stop part.

5. The switch device as set forth in claim 4, wherein
said temporary stop part can support said second arm part at the same height position in said axis direction as the position of said spring receiving part supporting said second arm portion.

6. The switch device as set forth in claim 2, wherein
the angle θ1 created by said first arm part and said second arm part when said arm part is supported by said spring receiving part is larger than the angle θ2 created by the same when said second arm part is supported by said temporary stop.

7. The switch device as set forth in claim 6, wherein
said temporary stop part is capable of supporting said second arm part at the different height position in said axial direction than the position of said spring receiving part supporting said second arm part; and
said second arm part slides in the direction along said axis to move from the state of being supported by said temporary stop part to the state of being supported by said spring receiving part.

8. The switch device as set forth in claim 1, wherein
said switch is a push-type switch.

9. The switch device as set forth in claim 1, wherein
said switch lever is provided with a second lever part which extends in a direction crossing said axial direction and the direction in which said first lever part extends; and
said switch switches the states thereof according to the position of said second lever part.

10. An actuator having the switch device as set forth in claim 1, comprising:
a motor;
a rotation transmission mechanism including a cam gear having a cam surface on which said first lever part abuts; and
an output member to which rotations of said motor are transmitted via said rotation transmission mechanism.

11. A clutch device having the actuator as set forth in claim 10, comprising:
a clutch member which is driven by said actuator to engage/disengage the connection of the mechanism.

12. A laundry machine having the clutch device as set forth in claim 11, comprising:
a laundry machine motor;
a tub;
a pulsator arranged inside said tub; and
a driving force transmission mechanism which transmits a rotation driving force of said motor to said tub and said pulsator;
wherein said driving force transmission mechanism has said clutch device along a way of a driving force transmission passage between said motor and said tub.
